(19) United States
(12) Patent Application Publication
(10) Pub. No.: US 2008/0033631 A1
(43) Pub. Date: Feb. 7, 2008

(54) Highway weaving free cloverleaf type interchange for a highway crossing under a street

(76) Inventor: Rene Yin, San Marino, CA (US)

Correspondence Address: Rene Yin, 2886 Gainsborough Drive, San Marino, CA, 91108, US

(21) Appl. No.: 11/500,218

(22) Filed: Aug. 5, 2006

(51) Int. Cl. G06F 19/00

(52) U.S. Cl. 701/117

(57) ABSTRACT

This highway weaving free cloverleaf type interchange for a highway crossing under a street accommodates traffic from a plurality of traveled ways which include a first traveled way for traffic traveling in a first direction, a second traveled way for traffic traveling in a direction opposite to the first direction, a third traveled way for traffic traveling in a direction intersecting the first and second traveled ways, and a fourth traveled way for traffic traveling in a direction opposite to the traffic traveling on the third traveled way. The first and second traveled ways cross under the third and fourth traveled ways in a first area Each of the first and second traveled ways has a design speed compatible to a highway or freeway design speed, or is designed according to highway or freeway design standards. Each of the third and fourth traveled ways has a design speed compatible to the design speed of a street, road, or conventional highway or is designed according to street, road, or conventional highway design standards. The first traveled way left turn ramp crosses the third traveled way left turn ramp and is disposed at an elevation distinct relative to that of the third traveled way left turn ramp in their overlapping area determined by bird's-eye view to enable traffic on the two ramps to cross each other without weaving. The third and fourth traveled ways are disposed in elevation between the first traveled way left turn ramp and the third traveled way left turn ramp to allow traffic on the third and fourth traveled ways to cross traffic on the two ramps without weaving. The second traveled way left turn ramp crosses the fourth traveled way left turn ramp and is disposed at an elevation distinct relative to that of the fourth traveled way left turn ramp in their overlapping area determined by bird's-eye view to enable traffic on the two ramps to cross each other without weaving. The third and fourth traveled ways are disposed in elevation between the second traveled way left turn ramp and the fourth traveled way left turn ramp to allow traffic on the third and fourth traveled ways to cross traffic on the two ramps without weaving. This interchange has a higher efficiency and a lower accident rate than a conventional cloverleaf type interchange for a highway crossing under a street. It uses only about the same amount of Right of Way as is commonly available for a conventional cloverleaf type interchange for a highway crossing under a street. It also has higher efficiency and requires less Right of Way at the street level than the interchange in U.S. Pat. No. 4,861,184 for a highway crossing under a street.

### CROSS-REFERENCES TO RELATED APPLICATIONS

Not applicable.

### FEDERALLY SPONSORED RESEARCH

Not applicable.

### SEQUENCE LISTING OR PROGRAM

Not applicable.

### BACKGROUND OF INVENTION

1. Field of Invention

This invention relates to cloverleaf type interchanges, specifically, to highway weaving free cloverleaf type interchanges in which a highway crosses under a street.

2. Prior Art

The conventional cloverleaf type interchange was patented on Feb. 29, 1916 under U.S. Pat. No. 1,173,505. It has the following disadvantages:

(a) This type of interchange for a highway crossing under a street has two highway weaving sections for fast traveling vehicles swapping lanes at grade. A proper highway weaving section requires a long weaving length and thus large Right of Way for traffic to weave safely and efficiently. If the Right of Way is not available, the traveling speed in each weaving section will decrease. Most local interchanges do not have such large Right of Way and thus can not achieve the required weaving length. Traffic approaching and inside each highway weaving section is slow because of the short weaving length. The Level of Service in each highway weaving section is usually F during peak hours in urban freeways. The rate of traffic passing through the interchange is low, and so is the efficiency of this interchange.

(b) Each highway weaving section is a source of traffic congestion on the highway because of the queue stretching from the highway weaving section to the highway.

(c) Each highway weaving section is a source of traffic congestion on the street because of the queue stretching from the highway weaving section to the street.

(d) Traffic accidents happen in front of and inside each highway weaving section because of the competition between the traffic getting on the highway and the traffic getting off the highway in the highway weaving section. These accidents are mostly sideswipe collisions, fender-fender collisions, and tail on collisions, characteristics of bad weaving. Some of these can be fatal. Thus, the cloverleaf type interchange has safety problems.

(e) The queues stretching from each highway weaving section toward the highway and street also produce traffic accidents on the highway and street.

Therefore, the conventional cloverleaf type interchange for a highway crossing under a street has low efficiency, causes traffic congestion, and bears safety problems because of the highway weaving sections.

An improvement to the conventional cloverleaf type interchange was patented on Aug. 29, 1989 under U.S. Pat. No. 4,861,184. However, it has the following disadvantages:

(a) This type of interchange for a highway crossing under a street can cause congestion and accidents if large Right of Way at street level is not available. The traffic from the left turn ramp of a highway traveled way mixes with the traffic from the right turn ramp of the opposite highway traveled way before reaching the street. The mixed traffic then merges with the street traffic at one location at the street. The total traffic volume in the single merge in U.S. Pat. No. 4,861,184 is the volume from the two highway off ramps plus the volume from the right lane of a street traveled way. This total traffic volume is relatively large and therefore requires a relatively long merging lane. If the required Right of Way at street level is not available, congestion and accidents happen inside the interchange, on the highway and the street. Traveling speeds inside the interchange are low.

(b) The efficiency of the interchange in this patent is limited because the large volume merge in a relatively small area reduces the traveling speed in the interchange.

(c) The interchange eliminates free U-turn movements from one highway traveled way to the opposite highway traveled way.

(d) The off ramps swinging over one or both highway traveled ways have a horizontal alignment of turning left, right, and left and a profile of going up and down. Traffic on such off-ramps needs to turn left, right, and then left while it goes up and down on the off ramps. The geometric design of the off ramps is not preferable.

(e) One of the embodiments employed exits from the left edge of highway traveled ways, which motorists are not accustomed to and is advised against in highway design.

(f) The other embodiment may encounter a structure span problem in the highway left turn off ramp if the highway traveled way is wide.

(g) Even if enough Right of Way is available at the street level, a fully functioning interchange of this type would use more Right of Way at the street level than a conventional cloverleaf type interchange for a highway crossing under a street.

Therefore, this improvement causes traffic congestion and accidents. Its geometric design is not preferable. The exits from the left edges of the highway traveled ways and the structure span problem limit its application.

The invention in my patent application titled “Highway Weaving Free Cloverleaf Type Local Interchange for a Highway Crossing Above a Street,” application Ser. No. 11/441,710, is more efficient and has less accidents. This invention requires only about the same amount of Right of Way as is commonly available for a conventional cloverleaf type interchange in the same situation. However, it only covers highway weaving free cloverleaf type interchanges in which a highway crosses above a street.

### OBJECTS AND ADVANTAGES

Several objects and advantages of the present invention are:

(a) to improve the traffic condition from the worst situation of Level of Service “F” in the highway weaving sections during peak hours to a flow free of disturbance by removing the weaving sections.

(b) to be more efficient than a conventional cloverleaf type interchange for a highway crossing under a street increasing the traveling speed inside the interchange after elimination of the highway weaving sections.

(c) to cause less traffic congestion on the highway and street by removing the highway weaving sections, the origin of the queue stretching to the highway and street.

(d) to eliminate all highway weaving related traffic accidents inside the interchange, on the highway, and on the street by removing the highway weaving sections.

(e) to require only about the same amount of Right of Way as is commonly available for a conventional cloverleaf type interchange for a highway crossing under a street.

(f) to be more efficient than the interchange in U.S. Pat. No. 4,861,184. The total traffic volume in the single merge in U.S. Pat. No. 4,861,184 is the volume from the two highway off ramps plus the volume from the right lane of a street traveled way. This total traffic volume is relatively large and therefore requires a relatively long merging lane. If the required Right of Way at the street level is not available, congestion and accidents happen inside the interchange, on the highway, and on the street. Traveling speeds inside the interchange are low. However, in the present invention, the traffic from the left turn ramp of a highway traveled way merges with the traffic on the right lane of a street traveled way. The total merging volume is smaller than the total merging volume in the interchange in U.S. Pat. No. 4,861,184. The merged traffic then evens itself among the lanes on the street traveled way before reaching the next merge. After that, the traffic from the right turn ramp of the opposite highway traveled way merges with the evened traffic traveling on the right lane of the street traveled way. The total volume is still smaller than the total traffic volume in the single merge in U.S. Pat. No. 4,861,184. Each of the two merges in this invention requires a shorter merging distance because of lower total volume. For street traveling speed and lower merging traffic volume, the present invention is more efficient and safer.

(g) to let traffic make a free U turn to the opposite traveled way of the highway, which can not be done in the interchange in U.S. Pat. No. 4,861,184.

(h) to have only one major turn in the left turn ramps of a highway traveled way instead of the three major turns in the left turn ramps of a highway traveled way in the interchange in U.S. Pat. No. 4,861,184.

(i) to encounter no structure span problem.

(j) to require less Right of Way at the street level for a normal operation than the interchange in U.S. Pat. No. 4,861,184.

(k) to have no ramps swinging over any highway traveled way and thus no uncomfortable feelings among motorists traveling on the highway.

Therefore, the present invention has higher efficiency and less traffic accidents than a conventional cloverleaf type interchange for a highway crossing under a street and uses only about the same amount of Right of Way.

### SUMMARY

This highway weaving free cloverleaf type interchange for a highway crossing under a street accommodates traffic from a plurality of traveled ways which include a first traveled way for traffic traveling in a first direction, a second traveled way for traffic traveling in a direction opposite to the first direction, a third traveled way for traffic traveling in a direction intersecting the first and second traveled ways, and a fourth traveled way for traffic traveling in a direction opposite to the traffic traveling on the third traveled way. The first and second traveled ways cross under the third and fourth traveled ways in a first area. Each of the first and second traveled ways has a design speed compatible to a highway or freeway design speed, or is designed according to highway or freeway design standards. Each of the third and fourth traveled ways has a design speed compatible to the design speed of a street, road, or conventional highway or is designed according to street, road, or conventional highway design standards. The first traveled way left turn ramp crosses the third traveled way left turn ramp and is disposed at an elevation distinct relative to that of the third traveled way left turn ramp in their overlapping area determined by bird's-eye view to enable traffic on the two ramps to cross each other without weaving. The third and fourth traveled ways are disposed in elevation between the first traveled way left turn ramp and the third traveled way left turn ramp to allow traffic on the third and fourth traveled ways to cross traffic on the two ramps without weaving. The second traveled way left turn ramp crosses the fourth traveled way left turn ramp and is disposed at an elevation distinct relative to that of the fourth traveled way left turn ramp in their overlapping area determined by bird's-eye view to enable traffic on the two ramps to cross each other without weaving. The third and fourth traveled ways are disposed in elevation between the second traveled way left turn ramp and the fourth traveled way left turn ramp to allow traffic on the third and fourth traveled ways to cross traffic on the two ramps without weaving. This interchange has a higher efficiency and a lower accident rate than a conventional cloverleaf type interchange for a highway crossing under a street. It uses only about the same amount of Right of Way as is commonly available for a conventional cloverleaf type interchange for a highway crossing under a street. It also has higher efficiency and requires less Right of Way at the street level than the interchange in U.S. Pat. No. 4,861,184 for a highway crossing under a street.

### DRAWINGS

Figures

FIG. 1.1, FIG. 1.2, and FIG. 1.3 show the preferred embodiment of the highway weaving free cloverleaf type interchange in which a highway crosses under a street.

FIG. 2.1, FIG. 2.2, and FIG. 2.3 show the first additional embodiment of the highway weaving free cloverleaf type interchange in which a highway crosses under a street.

FIG. 3.1, FIG. 3.2, and FIG. 3.3 show the second additional embodiment of the highway weaving free cloverleaf type interchange in which a highway crosses under a street.

### REFERENCE NUMERALS

1 A first traveled way for traffic traveling in a first direction.

2 A second traveled way for traffic traveling in a direction opposite to the first direction.

3 A third traveled way for traffic traveling in a direction intersecting the first and second traveled ways.

4 A fourth traveled way for traffic traveling in a direction opposite to the traffic traveling on the third traveled way.

5 A first traveled way left turn ramp.

6 A first traveled way right turn ramp.

7 A second traveled way left turn ramp.

8 A second traveled way right turn ramp.

9 A third traveled way left turn ramp.

10 A third traveled way right turn ramp.

11 A fourth traveled way left turn ramp.

12 A fourth traveled way right turn ramp.

### DETAILED DESCRIPTION

### Description of Preferred Embodiment

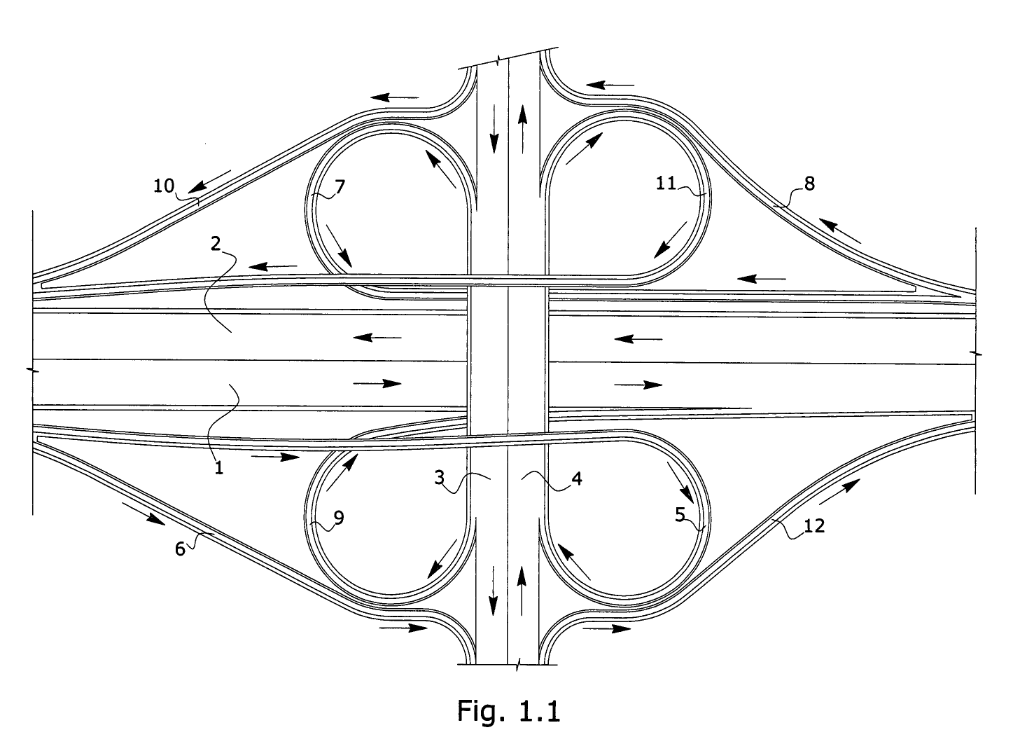

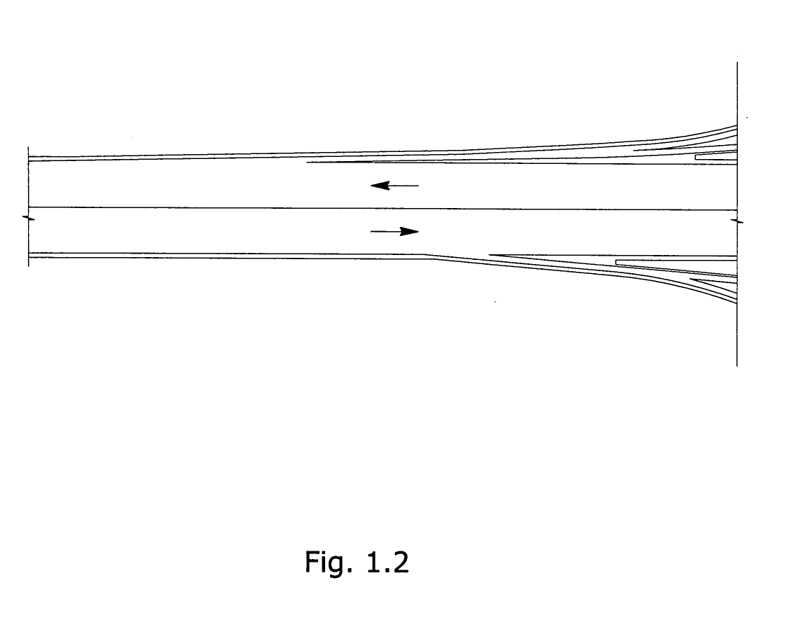

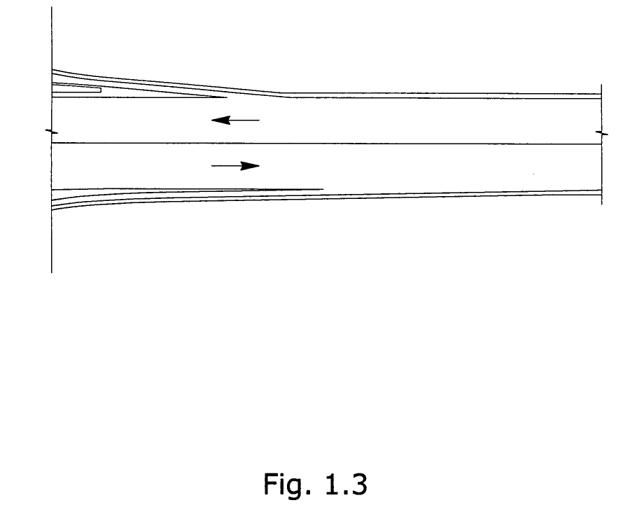

FIG. 1.1, FIG. 1.2, and FIG. 1.3 illustrate the preferred embodiment of the present invention. A first traveled way 1 is for traffic traveling in a first direction. A second traveled way 2 is for traffic traveling in a direction opposite to the first direction. A third traveled way 3 is for traffic traveling in a direction intersecting the first and second traveled ways 1, 2. A fourth traveled way 4 is for traffic traveling in a direction opposite to the traffic traveling on the third traveled way 3.

The first and second traveled ways 1, 2 cross under the third and fourth traveled ways 3, 4 in a first area.

Each of the first and second traveled ways 1, 2 has a design speed compatible to a highway or freeway design speed or is designed according to highway or freeway design standards. Each of the third and fourth traveled ways 3, 4 has a design speed compatible to the design speed of a street, road, or conventional highway or is designed according to street, road, or conventional highway design standards.

The first traveled way left turn ramp 5 forms a substantially circular cloverleaf section, is disposed at a predetermined first point along the right side of the first traveled way 1, and joins the right side of the fourth traveled way 4. The first traveled way right turn ramp 6 is disposed along the right side of the first traveled way 1, and joins the right side of the third traveled way 3. The second traveled way left turn ramp 7 forms a substantially circular cloverleaf section, is disposed at a predetermined second point along the right side of the second traveled way 2, and joins the right side of the third traveled way 3. The second traveled way right turn ramp 8 is disposed along the right side of the second traveled way 2, and joins the right side of the fourth traveled way 4. The third traveled way left turn ramp 9 forms a substantially circular cloverleaf section, is disposed at a predetermined third point along the right side of the third traveled way 3, and joins the right side of the first traveled way 1. The third traveled way right turn ramp 10 is disposed along the right side of the third traveled way 3, and joins the right side of the second traveled way 2. The fourth traveled way left turn ramp 11 forms a substantially circular cloverleaf section, is disposed at a predetermined fourth point along the right side of the fourth traveled way 4, and joins the right side of the second traveled way 2. The fourth traveled way right turn ramp 12 is disposed along the right side of the fourth traveled way 4, and joins the right side of the first traveled way 1.

The first traveled way left turn ramp 5 crosses above the third traveled way left turn ramp 9. The third and fourth traveled ways 3, 4 cross above the third traveled way left turn ramp 9 and cross under the first traveled way left turn ramp 5. The fourth traveled way left turn ramp 11 crosses above the second traveled way left turn ramp 7. The third and fourth traveled ways 3, 4 cross above the second traveled way left turn ramp 7 and cross under the fourth traveled way left turn ramp 11.

### Operation of Preferred Embodiment

The first traveled way left turn ramp 5 diverts traffic from the first traveled way 1 to the fourth traveled way 4. The first traveled way right turn ramp 6 diverts traffic from the first traveled way 1 to the third traveled way 3. The second traveled way left turn ramp 7 diverts traffic from the second traveled way 2 to the third traveled way 3. The second traveled way right turn ramp 8 diverts traffic from the second traveled way 2 to the fourth traveled way 4. The third traveled way left turn ramp 9 diverts traffic from the third traveled way 3 to the first traveled way 1. The third traveled way right turn ramp 10 diverts traffic from the third traveled way 3 to the second traveled way 2. The fourth traveled way left turn ramp 11 diverts traffic from the fourth traveled way 4 to the second traveled way 2. The fourth traveled way right turn ramp 12 diverts traffic from the fourth traveled way 4 to the first traveled way 1.

The traffic on the first traveled way left turn ramp 5 crosses above the traffic on the third traveled way left turn ramp 9. The traffic on the third and fourth traveled ways 3, 4 crosses above the traffic on the third traveled way left turn ramp 9 and crosses under the traffic on the first traveled way left turn ramp 5. The traffic on the fourth traveled way left turn ramp 11 crosses above the traffic on the second traveled way left turn ramp 7. The traffic on the third and fourth traveled ways 3, 4 crosses above the traffic on the second traveled way left turn ramp 7 and crosses under the traffic on the fourth traveled way left turn ramp 11.

### Description of the First Additional Embodiment

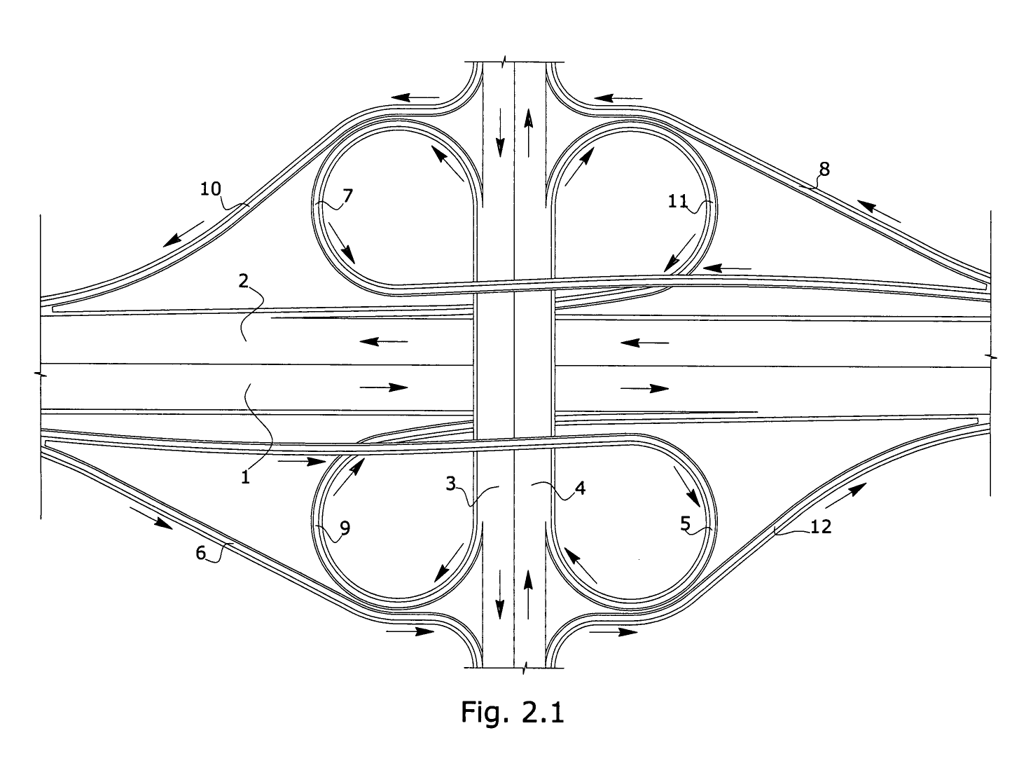

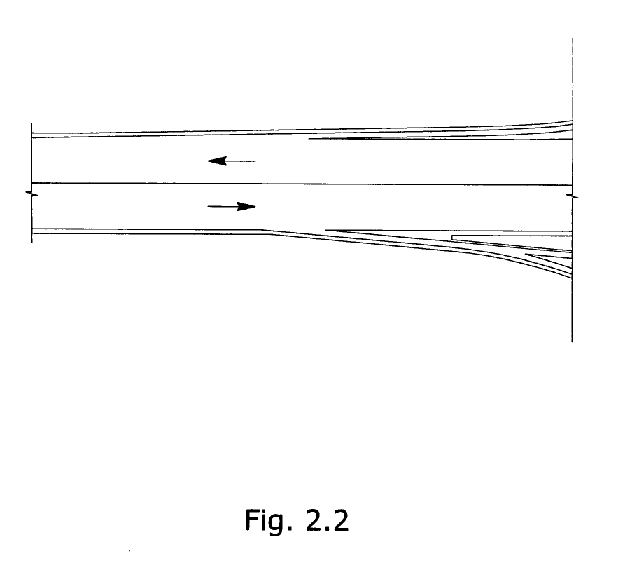

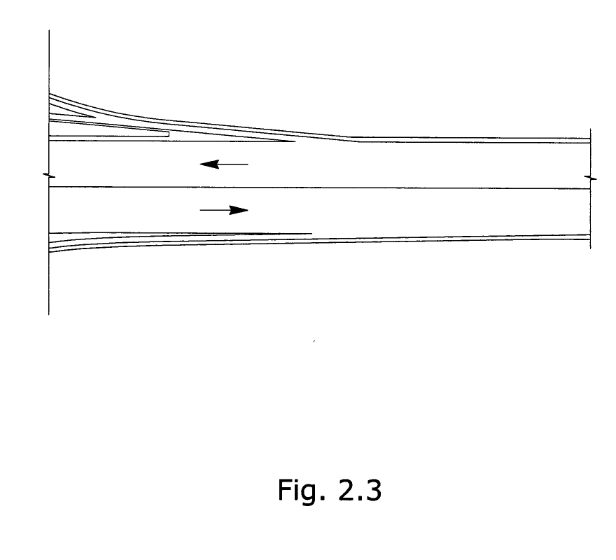

FIG. 2. 1, FIG. 2.2, and FIG. 2.3 illustrate the first additional embodiment of the present invention. A first traveled way 1 is for traffic traveling in a first direction. A second traveled way 2 is for traffic traveling in a direction opposite to the first direction. A third traveled way 3 is for traffic traveling in a direction intersecting the first and second traveled ways 1, 2. A fourth traveled way 4 is for traffic traveling in a direction opposite to the traffic traveling on the third traveled way 3.

The first and second traveled ways 1, 2 cross under the third and fourth traveled ways 3, 4 in a first area.

Each of the first and second traveled ways 1, 2 has a design speed compatible to a highway or freeway design speed or is designed according to highway or freeway design standards. Each of the third and fourth traveled ways 3, 4 has a design speed compatible to the design speed of a street, road, or conventional highway or is designed according to street, road, or conventional highway design standards.

The first traveled way left turn ramp 5 forms a substantially circular cloverleaf section, is disposed at a predetermined first point along the right side of the first traveled way 1, and joins the right side of the fourth traveled way 4. The first traveled way right turn ramp 6 is disposed along the right side of the first traveled way 1, and joins the right side of the third traveled way 3. The second traveled way left turn ramp 7 forms a substantially circular cloverleaf section, is disposed at a predetermined second point along the right side of the second traveled way 2, and joins the right side of the third traveled way 3. The second traveled way right turn ramp 8 is disposed along the right side of the second traveled way 2, and joins the right side of the fourth traveled way 4. The third traveled way left turn ramp 9 forms a substantially circular cloverleaf section, is disposed at a predetermined third point along the right side of the third traveled way 3, and joins the right side of the first traveled way 1. The third traveled way right turn ramp 10 is disposed along the right side of the third traveled way 3, and joins the right side of the second traveled way 2. The fourth traveled way left turn ramp 11 forms a substantially circular cloverleaf section, is disposed at a predetermined fourth point along the right side of the fourth traveled way 4, and joins the right side of the second traveled way 2. The fourth traveled way right turn ramp 12 is disposed along the right side of the fourth traveled way 4, and joins the right side of the first traveled way 1.

The first traveled way left turn ramp 5 crosses above the third traveled way left turn ramp 9. The third and fourth traveled ways 3, 4 cross above the third traveled way left turn ramp 9 and cross under the first traveled way left turn ramp 5. The second traveled way left turn ramp 7 crosses above the fourth traveled way left turn ramp 11. The third and fourth traveled ways 3, 4 cross above the fourth traveled way left turn ramp 11 and cross under the second traveled way left turn ramp 7.

### Operation of the First Additional Embodiment

The first traveled way left turn ramp 5 diverts traffic from the first traveled way 1 to the fourth traveled way 4. The first traveled way right turn ramp 6 diverts traffic from the first traveled way 1 to the third traveled way 3. The second traveled way left turn ramp 7 diverts traffic from the second traveled way 2 to the third traveled way 3. The second traveled way right turn ramp 8 diverts traffic from the second traveled way 2 to the fourth traveled way 4. The third traveled way left turn ramp 9 diverts traffic from the third traveled way 3 to the first traveled way 1. The third traveled way right turn ramp 10 diverts traffic from the third traveled way 3 to the second traveled way 2. The fourth traveled way left turn ramp 11 diverts traffic from the fourth traveled way 4 to the second traveled way 2. The fourth traveled way right turn ramp 12 diverts traffic from the fourth traveled way 4 to the first traveled way 1.

The traffic on the first traveled way left turn ramp 5 crosses above the traffic on the third traveled way left turn ramp 9. The traffic on the third and fourth traveled ways 3, 4 crosses above the traffic on the third traveled way left turn ramp 9 and crosses under the traffic on the first traveled way left turn ramp 5. The traffic on the second traveled way left turn ramp 7 crosses above the traffic on the fourth traveled way left turn ramp 11. The traffic on the third and fourth traveled ways 3, 4 crosses above the traffic on the fourth traveled way left turn ramp 11 and crosses under the traffic on the second traveled way left turn ramp 7.

### Description of the Second Additional Embodiment

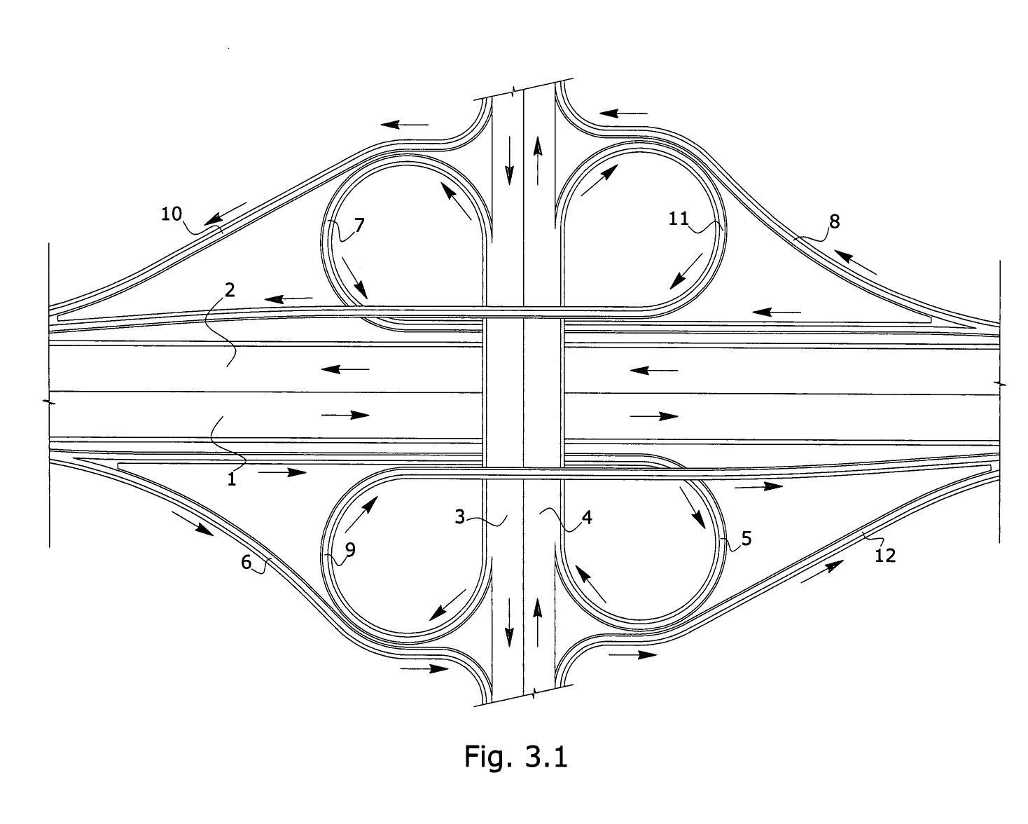

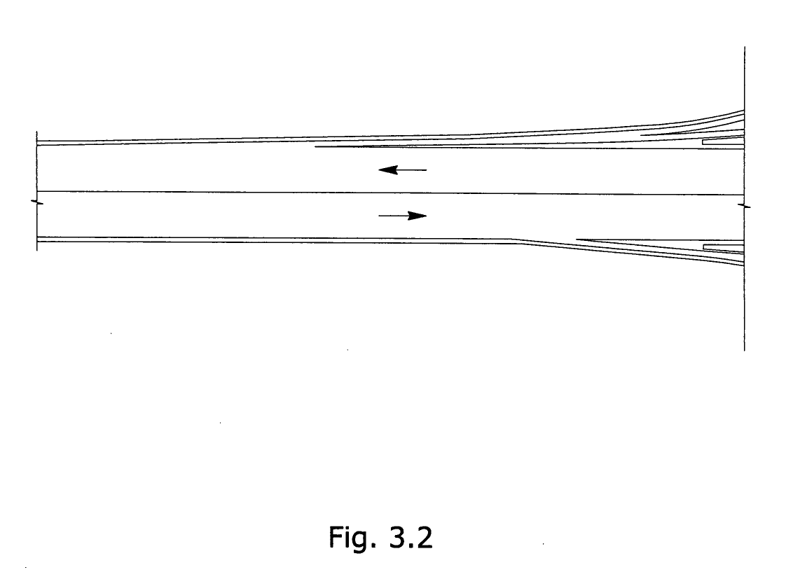

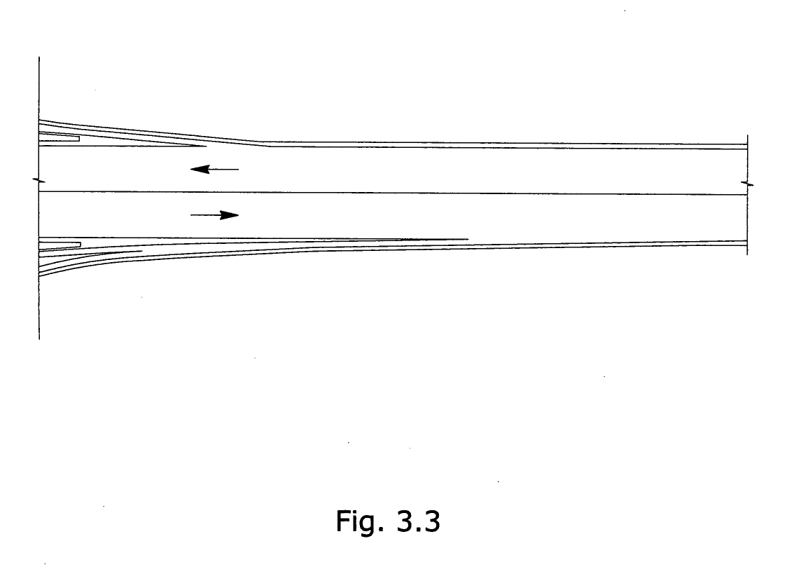

FIG. 3.1, FIG. 3.2, and FIG. 3.3 illustrate the second additional embodiment of present invention. A first traveled way 1 is for traffic traveling in a first direction. A second traveled way 2 is for traffic traveling in a direction opposite to the first direction. A third traveled way 3 is for traffic traveling in a direction intersecting the first and second traveled ways 1, 2. A fourth traveled way 4 is for traffic traveling in a direction opposite to the traffic traveling on the third traveled way 3.

The first and second traveled ways 1, 2 cross under the third and fourth traveled ways 3, 4 in a first area.

Each of the first and second traveled ways 1, 2 has a design speed compatible to a highway or freeway design speed or is designed according to highway or freeway design standards. Each of the third and the fourth traveled ways 3, 4 has a design speed compatible to the design speed of a street, road, or conventional highway or is designed according to street, road, or conventional highway design standards.

The first traveled way left turn ramp 5 forms a substantially circular cloverleaf section, is disposed at a predetermined first point along the right side of the first traveled way 1, and joins the right side of the fourth traveled way 4. The first traveled way right turn ramp 6 is disposed along the right side of the first traveled way 1, and joins the right side of the third traveled way 3. The second traveled way left turn ramp 7 forms a substantially circular cloverleaf section, is disposed at a predetermined second point along the right side of the second traveled way 2, and joins the right side of the third traveled way 3. The second traveled way right turn ramp 8 is disposed along the right side of the second traveled way 2, and joins the right side of the fourth traveled way 4. The third traveled way left turn ramp 9 forms a substantially circular cloverleaf section, is disposed at a predetermined third point along the right side of the third traveled way 3, and joins the right side of the first traveled way 1. The third traveled way right turn ramp 10 is disposed along the right side of the third traveled way 3, and joins the right side of the second traveled way 2. The fourth traveled way left turn ramp 11 forms a substantially circular cloverleaf section, is disposed at a predetermined fourth point along the right side of the fourth traveled way 4, and joins the right side of the second traveled way 2. The fourth traveled way right turn ramp 12 is disposed along the right side of the fourth traveled way 4, and joins the right side of the first traveled way 1.

The third traveled way left turn ramp 9 crosses above the first traveled way left turn ramp 5. The third and fourth traveled ways 3, 4 cross above the first traveled way left turn ramp 5 and cross under the third traveled way left turn ramp 9. The fourth traveled way left turn ramp 11 crosses above the second traveled way left turn ramp 7. The third and fourth traveled ways 3, 4 cross above the second traveled way left turn ramp 7 and cross under the fourth traveled way left turn ramp 11.

### Operation of the Second Additional Embodiment

The first traveled way left turn ramp 5 diverts traffic from the first traveled way 1 to the fourth traveled way 4. The first traveled way right turn ramp 6 diverts traffic from the first traveled way 1 to the third traveled way 3. The second traveled way left turn ramp 7 diverts traffic from the second traveled way 2 to the third traveled way 3. The second traveled way right turn ramp 8 diverts traffic from the second traveled way 2 to the fourth traveled way 4. The third traveled way left turn ramp 9 diverts traffic from the third traveled way 3 to the first traveled way 1. The third traveled way right turn ramp 10 diverts traffic from the third traveled way 3 to the second traveled way 2. The fourth traveled way left turn ramp 11 diverts traffic from the fourth traveled way 4 to the second traveled way 2. The fourth traveled way right turn ramp 12 diverts traffic from the fourth traveled way 4 to the first traveled way 1.

The traffic on the third traveled way left turn ramp 9 crosses above the traffic on the first traveled way left turn ramp 5. The traffic on the third and fourth traveled ways 3, 4 crosses above the traffic on the first traveled way left turn ramp 5 and crosses under the traffic on the third traveled way left turn ramp 9. The traffic on the fourth traveled way left turn ramp 11 crosses above the traffic on the second traveled way left turn ramp 7. The traffic on the third and fourth traveled ways 3, 4 crosses above the traffic on the second traveled way left turn ramp 7 and crosses under the traffic on the fourth traveled way left turn ramp 11.

### Conclusion, Ramifications, and Scope

Accordingly, the reader will see that the interchange eliminate highway weaving sections and provide free flow for all movements. The traffic condition improves from Level of Service “F in the highway weaving sections to a flow free of disturbance. The efficiency of this interchange increases.

Highway weaving related traffic accidents inside the interchange are eliminated. Accidents on the highway and street caused by blockage from the weaving traffic are also eliminated. Safety of the interchange improves. This improvement prevents injuries and save lives.

The interchange use about the same amount of Right of Way as conventional cloverleaf type interchanges for a highway crossing under a street.

Although the description above contains many specifications, these should not be construed as limiting the scope of the invention but as merely providing illustrations of some of the presently preferred embodiments of this invention. Many other variations are possible. For example, the third and fourth traveled ways 3, 4 can cross above all the eight ramps. The left turn ramp and right turn ramp of one highway traveled way can use the same highway exit. Optionally, each of the two ramps can have its own separate highway exit. The left turn ramp of one street traveled way and the right turn ramp of the opposite street traveled way can share the same highway entrance. Alternatively, each of the two ramps can have its own highway entrance.

Thus the scope of the invention should be determined by the appended claims and their legal equivalents, rather than by the examples given.

I claim:

1. An interchange, comprising:
(a) a first traveled way for traffic traveling in a first direction,
(b) a second traveled way for traffic traveling in a direction opposite to said first direction,
(c) a third traveled way for traffic traveling in a direction intersecting said first and second traveled ways,
(d) a fourth traveled way for traffic traveling in a direction opposite to said traffic traveling on said third traveled way,
(e) said first and second traveled ways crossing under said third and fourth traveled ways in a first area,
(f) each of said third and fourth traveled ways having a design speed compatible to the design speed of a street, road, or conventional highway,
(g) a first traveled way left turn ramp forming a substantially circular cloverleaf section, being disposed at a predetermined first point along the right side of said first traveled way, joining the right side of said fourth traveled way, and diverting traffic from said first traveled way to said fourth traveled way,
(h) a first traveled way right turn ramp being disposed along the right side of said first traveled way, joining the right side of said third traveled way, and diverting traffic from said first traveled way to said third traveled way,
(i) a third traveled way left turn ramp forming a substantially circular cloverleaf section, being disposed at a predetermined third point along the right side of said third traveled way, joining the right side of said first traveled way, and diverting traffic from said third traveled way to said first traveled way,
(j) a fourth traveled way right turn ramp being disposed along the right side of said fourth traveled way, joining the right side of said first traveled way, and diverting traffic from said fourth traveled way to said first traveled way,
(k) said first traveled way left turn ramp crossing said third traveled way left turn ramp and being disposed at an elevation distinct relative to that of said third traveled way left turn ramp in their overlapping area determined by bird's-eye view to enable traffic on the two ramps to cross each other without weaving,
whereby the interchange without any highway weaving section provides higher efficiency and safety.

2. The interchange of claim 1 wherein said first traveled way left turn ramp crosses above said third traveled way left turn ramp to enable traffic on the two ramps to cross each other without weaving, and said third and fourth traveled ways cross above said third traveled way left turn ramp and cross under said first traveled way left turn ramp to allow traffic on said third and fourth traveled ways to cross traffic on the two ramps without weaving.

3. The interchange of claim 1 wherein said third traveled way left turn ramp crosses above said first traveled way left turn ramp to enable traffic on the two ramps to cross each other without weaving, and said third and fourth traveled ways cross above said first traveled way left turn ramp and cross under said third traveled way left turn ramp to allow traffic on said third and fourth traveled ways to cross traffic on the two ramps without weaving.

4. An interchange, comprising:
(a) a first traveled way for traffic traveling in a first direction,
(b) a second traveled way for traffic traveling in a direction opposite to said first direction,
(c) a third traveled way for traffic traveling in a direction intersecting said first and second traveled ways,
(d) a fourth traveled way for traffic traveling in a direction opposite to said traffic traveling on said third traveled way,
(e) said first and second traveled ways crossing under said third and fourth traveled ways in a first area,
(f) each of said third and fourth traveled ways having a design speed compatible to the design speed of a street, road, or conventional highway,
(g) a first traveled way left turn ramp forming a substantially circular cloverleaf section, being disposed at a predetermined first point along the right side of said first traveled way, joining the right side of said fourth traveled way, and diverting traffic from said first traveled way to said fourth traveled way,
(h) a first traveled way right turn ramp being disposed along the right side of said first traveled way, joining the right side of said third traveled way, and diverting traffic from said first traveled way to said third traveled way,
(i) a third traveled way left turn ramp forming a substantially circular cloverleaf section, being disposed at a predetermined third point along the right side of said third traveled way, joining the right side of said first traveled way, and diverting traffic from said third traveled way to said first traveled way,
(j) a fourth traveled way right turn ramp being disposed along the right side of said fourth traveled way, joining the right side of said first traveled way, and diverting traffic from said fourth traveled way to said first traveled way,
(k) said first traveled way left turn ramp crossing said third traveled way left turn ramp and being disposed at an elevation distinct relative to that of said third traveled way left turn ramp in their overlapping area determined by bird's-eye view to enable traffic on the two ramps to cross each other without weaving,
(l) a second traveled way left turn ramp forming a substantially circular cloverleaf section, being disposed at a predetermined second point along the right side of said second traveled way, joining the right side of said third traveled way, and diverting traffic from said second traveled way to said third traveled way,
(m) a second traveled way right turn ramp being disposed along the right side of said second traveled way, joining the right side of said fourth traveled way, and diverting traffic from said second traveled way to said fourth traveled way,
(n) a fourth traveled way left turn ramp forming a substantially circular cloverleaf section, being disposed at a predetermined fourth point along the right side of said fourth traveled way, joining the right side of said second traveled way, and diverting traffic from said fourth traveled way to said second traveled way,
(o) a third traveled way right turn ramp being disposed along the right side of said third traveled way, joining the right side of said second traveled way, and diverting traffic from said third traveled way to said second traveled way,
(p) said second traveled way left turn ramp crossing said fourth traveled way left turn ramp and being disposed at an elevation distinct relative to that of said fourth traveled way left turn ramp in their overlapping area determined by bird's-eye view to enable traffic on the two ramps to cross each other without weaving.
whereby the interchange without any highway weaving sections provides higher efficiency and safety.

5. The interchange of claim 4 wherein said first traveled way left turn ramp crosses above said third traveled way left turn ramp to enable traffic on the two ramps to cross each other without weaving, and said third and fourth traveled ways cross above said third traveled way left turn ramp and cross under said first traveled way left turn ramp to allow traffic on said third and fourth traveled ways to cross traffic on the two ramps without weaving.

6. The interchange of claim 4 wherein said third traveled way left turn ramp crosses above said first traveled way left turn ramp to enable traffic on the two ramps to cross each other without weaving, and said third and fourth traveled ways cross above said first traveled way left turn ramp and cross under said third traveled way left turn ramp to allow traffic on said third and fourth traveled ways to cross traffic on the two ramps without weaving.

7. The interchange of claim 4 wherein said second traveled way left turn ramp crosses above said fourth traveled way left turn ramp to enable traffic on the two ramps to cross each other without weaving, and said third and fourth traveled ways cross above said fourth traveled way left turn ramp and cross under said second traveled way left turn ramp to allow traffic on said third and fourth traveled ways to cross traffic on the two ramps without weaving.

8. The interchange of claim 4 wherein said fourth traveled way left turn ramp crosses above said second traveled way left turn ramp to enable traffic on the two ramps to cross each other without weaving, and said third and fourth traveled ways cross above said second traveled way left turn ramp and cross under said fourth traveled way left turn ramp to allow traffic on said third and fourth traveled ways to cross traffic on the two ramps without weaving.
